(19) United States
(12) Patent Application Publication
(10) Pub. No.: US 2026/0175302 A1
(43) Pub. Date: Jun. 25, 2026

(54) CUTTING INSERT AND ROTARY CUTTING TOOL

(71) Applicant: KANEFUSA KABUSHIKI KAISHA, Niwa-gun (JP)

(72) Inventors: Eisuke MUTO, Niwa-gun (JP); Yasunari YAMADA, Niwa-gun (JP); Yuta MASU, Niwa-gun (JP)

(73) Assignee: KANEFUSA KABUSHIKI KAISHA, Niwa-gun (JP)

(21) Appl. No.: 19/127,615

(22) PCT Filed: Nov. 6, 2023
(86) PCT No.: PCT/JP2023/039910

§ 371 Date: May 6, 2025

(30) Foreign Application Priority Data
Nov. 7, 2022 (JP) 2022-178491

(51) Int. Cl. B23B 51/06; B23C 5/06; B23C 5/10

(52) U.S. Cl. CPC B23B 51/06; B23C 5/06; B23C 5/10; B23C 2210/282

(57) ABSTRACT

An object is to provide a cutting insert having improved durability. For solving the problem, the cutting insert of the present disclosure includes a major cutting edge 11a and a wiper insert 11b each formed of CBN. A chamfer 1124 extending to the major cutting edge 11a and including a smooth surface formed at least near the major cutting edge 11a is formed on a rake surface 1121 of the wiper insert 11b. The smooth chamfer eliminates a portion on which stress concentrates, and prevents occurrence of chipping or the like, thereby improving durability. A portion of the chamfer on the major cutting edge side preferably has a rounded convex shape. Since the portion on the major cutting edge side is formed in a rounded convex shape, an effect similar to that obtained when a chamfer is formed without formation of a ridgeline portion is obtained.

### TECHNICAL FIELD

The present disclosure relates to a cutting insert including a major cutting edge and a wiper insert both of which are formed of CBN, and a rotary cutting tool.

### BACKGROUND ART

In a rotary cutting tool such as a face mill for machining high hardness steel including cast iron, an about 150 to 450 negative chamfer is applied to each of a major cutting edge and a wiper insert.

### CITATION LIST

### Patent Literature

Patent Literature 1: JP6704223 (B)

### SUMMARY OF INVENTION

### Technical Problem

In order to improve the durability of a cutting insert including a major cutting edge and a wiper insert both of which are formed of CBN, the present inventors have conducted studies. As a result, the present inventors have found that a ridgeline at which chamfers of the major cutting edge and the wiper insert meet acts on a workpiece, and stress is concentrated on the ridgeline and leads to, for example, chipping starting from the ridgeline portion, and that the durability is improved by eliminating the ridgeline.

The present disclosure has been completed in view of the above circumstances, and an object of the present disclosure is to provide a cutting insert having improved durability and a rotary cutting tool.

### Solution to Problem

A cutting insert according to the present disclosure for achieving the above object includes a major cutting edge and a wiper insert which are formed of CBN, and a chamfer extending to the major cutting edge and including a smooth surface formed at least near the major cutting edge is formed on a rake surface of the wiper insert.

A smooth chamfer is formed on the wiper insert and not the major cutting edge, whereby a ridgeline on which stress is concentrated is eliminated and occurrence of chipping or the like is prevented, thereby improving durability.

In addition, the chamfer preferably has a rounded convex shape on the major cutting edge side. With the rounded convex shape on the major cutting edge side, an effect similar to that obtained in a case where a chamfer is formed without formation of the ridgeline portion is obtained.

A rotary cutting tool according to the present disclosure for achieving the above object includes:
a blade part which includes a major cutting edge and a wiper insert which are formed of CBN, and in which a chamfer extending to the major cutting edge and including a smooth surface formed at least near the major cutting edge is formed on a rake surface of the wiper insert; and
a base part for securing the blade part.

The blade part has a cutting edge angle that is greater than 0° and smaller than 90°, a true rake angle that is −42° or greater and −13° or smaller, and a major cutting edge inclination angle that is −5° or greater and smaller than +5°, and an axial rake of a surface other than the chamfer of the rake surface is 0° or greater in the blade part.

Since the cutting edge angle, the true rake angle, and the major cutting edge inclination angle are in the above range, the durability of the major cutting edge is improved. In addition, since the axial rake of a surface other than the chamfer of the rake surface is 0° or greater, swarf moving along the chamfer moves away when the swarf reaches surfaces other than the chamfer of the rake surface, so that swarf is discharged easily.

### BRIEF DESCRIPTION OF DRAWINGS

FIG. 1A is a front view of a rotary cutting tool according to the present embodiment;

FIG. 1B illustrates a cutting edge angle of a major cutting edge, a true rake angle, a major cutting edge inclination angle, an axial rake, and a radial rake, in the rotary cutting tool according to the present embodiment;

FIG. 2 is a perspective view of the rotary cutting tool according to the present embodiment;

FIG. 3 is a perspective view of a placement block for securing a blade part of the rotary cutting tool according to the present embodiment;

FIG. 4 is a perspective view showing a state where the blade part is secured to the placement block shown in FIG. 3;

FIG. 5 is a perspective view of a cutting insert of the rotary cutting tool according to the present embodiment;

FIG. 6 is a perspective view of the blade part of the rotary cutting tool according to the present embodiment;

FIG. 7 is a perspective view of a blade part of a rotary cutting tool according to modification 1;

FIG. 8 is an enlarged view of a portion of a chamfer near a major cutting edge in the blade part in FIG. 7; and

FIG. 9 is a perspective view of a blade part of a rotary cutting tool according to modification 2.

### DESCRIPTION OF EMBODIMENT

A cutting insert and a rotary cutting tool of the present disclosure will be described in detail below, based on an embodiment. The rotary cutting tool of the present embodiment is a tool having a major cutting edge formed on the outer circumference portion, and for performing cutting work with the outer circumference portion. A wiper insert is formed on the front end side.

The rotary cutting tool of the present embodiment is suitably used for milling cutters such as a face mill and an end mill. The milling cutter of the present embodiment is preferably used, particularly, for machining steel materials such as cast iron.

As used herein, a side that comes into contact with a workpiece is referred to as front end and a side opposite to the front end is referred to as rear end, in a rotation axis direction of the rotary cutting tool. When a numerical range is newly defined, numerical values described herein may be adopted discretionarily as the upper limit or the lower limit of the new numerical range, and further, the numerical values adopted for the numerical range may or may not be included.

In the rotary cutting tool of the present embodiment, both the major cutting edge and the wiper insert are formed of a hard sintered body composed of CBN. The size of the rotary cutting tool of the present embodiment is not particularly limited. The lower limit value of an outer diameter is 10 mm, 15 mm, 20 mm, 25 mm, or 30 mm, and the upper limit value of the outer diameter is 500 mm, 300 mm, 200 mm, or 100 mm, for example.

As used herein, the drawings are schematic. In the drawings, for facilitating the understanding, the scale or structure of the details is emphasized or omitted. In addition, elements having the same function are denoted by the same reference characters in some cases even if the elements are different.

### Embodiment

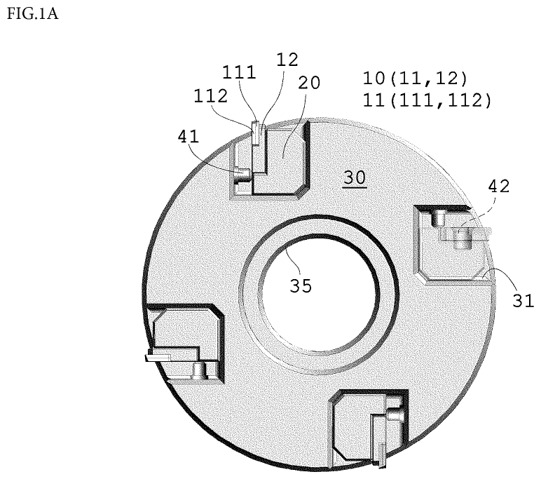

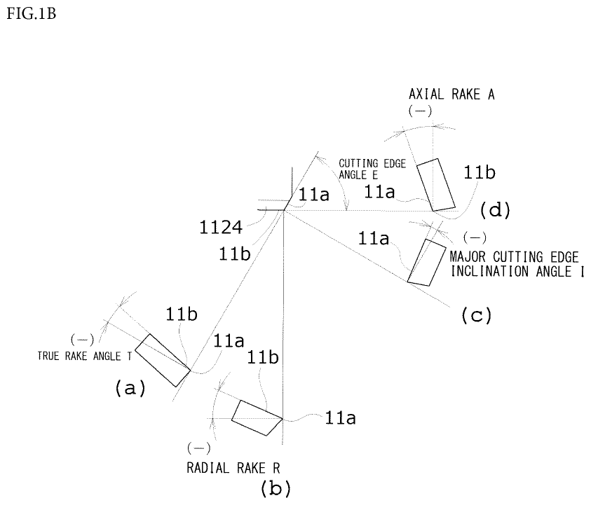

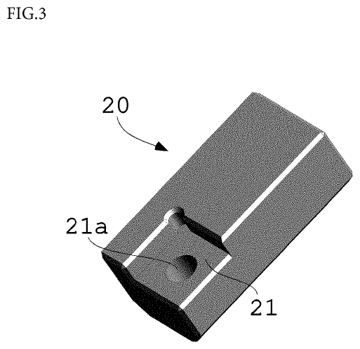

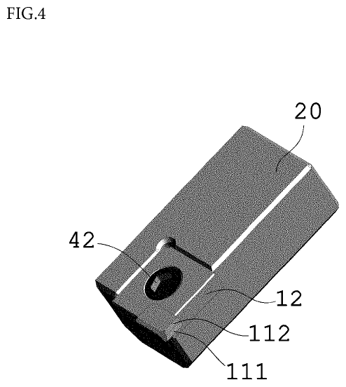

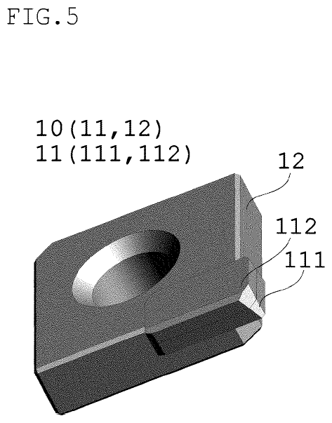

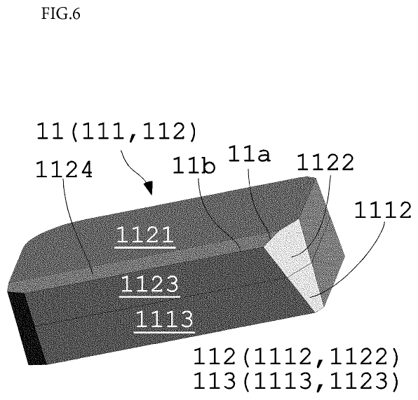

The rotary cutting tool of the present embodiment is a face mill, and rotates counterclockwise as seen from the front end side. As shown in FIGS. 1A to 6, the rotary cutting tool of the present embodiment includes a body 30, and four cutting inserts 10 secured at equal pitches to the outer circumference of the front end portion of the body 30. Each cutting insert 10 is secured to the body 30 with a placement block 20 therebetween.

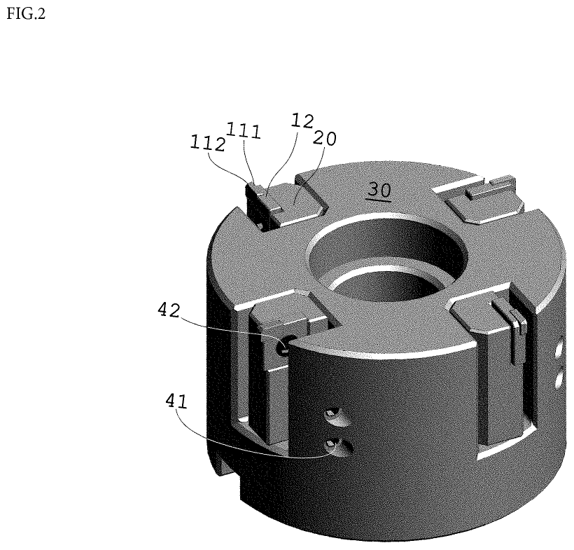

FIG. 1A is a front view of the rotary cutting tool of the present embodiment, as seen from the front end side, and a relief surface 113 of a wiper insert 11b of each of a plurality of the cutting inserts 10 faces the front side of the drawing. FIG. 2 is a perspective view of the rotary cutting tool of the present embodiment.

Each cutting insert 10 is secured detachably to a seat 21 of the placement block 20 by a screw 42. The screw 42 is fastened into a screw hole 21a formed in the seat 21 of the placement block 20. The placement block 20 is inserted into a securing pocket 31 formed in the body 30, and then is secured with a screw 41. The cutting insert 10 is secured in a forward direction relative to the rotation direction (counterclockwise direction in FIG. 1A) about the rotation axis of the rotary cutting tool of the present embodiment. That is, the cutting insert 10 is considered to be secured so as to be rotated while lagging in the rotation direction toward the outer portion in the radial direction.

The cutting insert 10 has a base metal 12, and a blade part 11 fixed to the base metal 12 by brazing. The blade part 11 is formed of a CBN layer 112 and a cemented carbide layer 111 fixed to the base metal 12, and a major cutting edge 11a and a wiper insert 11b are formed in the CBN layer 112.

A chamfer 1124 is formed on a rake surface 1121 of the wiper insert 11b. In the present embodiment, the chamfer 1124 is a part of a flat surface, and meets the major cutting edge 11a as it is. The chamfer 1124 is formed so as to have a constant width from the wiper insert 11b. The chamfer 1124 is formed at one side of a CBN flat surface by grinding with a grindstone, laser processing, or the like. The cemented carbide layer 111 and the CBN layer 112, and a relief surface 112 (1112, 1122) of the major cutting edge 11a and a relief surface 113 (1113, 1123) of the wiper insert 11b are joined to each other without a level difference. However, the present invention is not particularly limited.

Here, the chamfer 1124 is composed of a smooth surface. A range in the chamfer 1124 which is to be determined as being composed of the smooth surface is a surface near the major cutting edge 11a. That is, the rotary cutting tool of the present embodiment is formed such that a portion near the major cutting edge 11a is composed of the smooth surface. The reason is that, when a ridgeline at which two or more surfaces meet is present at a portion near the major cutting edge 11a, stress is concentrated on the ridgeline, so that chipping is more likely to occur. The portion near the major cutting edge 11a means a portion that is distant from the major cutting edge 11a by a distance corresponding to about a feed amount per blade or smaller. That is, a portion that comes into contact with a workpiece during cutting is the portion near the major cutting edge 11a. For example, a portion within 0.5 mm (preferably 0.4 mm, more preferably 0.3 mm, and further preferably 0.2 mm) from the major cutting edge 11a is regarded as the portion near the major cutting edge 11a, and such a portion is preferably composed of the smooth surface.

The body 30 is formed of an alloy tool steel. The body 30 has an approximately cylindrical outer shape, and has a length of 49.5 mm in the rotation axis direction and an outer diameter of 62 mm. The body 30 has a fitting hole 35 so as to be connected to a machining device. The fitting hole 35 penetrates to the front end portion. The rotary cutting tool is fastened to the machining device on the rear end side by a bolt through the fitting hole 35. Further, the body 30 may be separatable. For example, the body 30 is separated, in the axis direction, into a part for securing the cutting insert 10 and a part other that the part for securing the cutting insert 10. When the material of the part other than the part for securing the cutting insert 10 is an aluminum alloy or the like, reduction in weight and cost is made possible.

The placement blocks 20 on which the cutting inserts 10 are screwed are secured to the outer circumference of the front end portion of the body 30 at equal 90° pitches (unequal pitches are also applicable) in the circumferential direction. A groove is formed on the front side of each cutting insert 10 in the rotation direction (counterclockwise direction as seen from the front end side). A relief is formed on the rear side of the cutting insert 10 in the rotation direction.

The major cutting edge 11a and the wiper insert 11b meet at an angle of 120°. The wiper insert 11b has a shape that slightly protrudes in the front end direction (shape having the center portion protruding in the outer direction: rounded convex shape). The blade width of the wiper insert 11b is 4.2 mm, and the protruding length of the most greatly protruding center portion from a line segment connecting both the ends of the blade of the wiper insert 11b is about 11 μm. The protruding length is about 1 μm to 20 μm.

The cutting insert 10 secured to the body 30 with the placement block 20 therebetween has a cutting edge angle that is greater than 0° and smaller than 90°, a true rake angle of −13° to −42°, and a major cutting edge inclination angle of −5° to +5°.

The major cutting edge 11a has a cutting edge angle that is fixed, changes on the way, forms a round shape, or is different for each of the plurality of cutting inserts 10.

The cutting edge angle has an upper limit value of 65°, 75°, or 85°, and a lower limit value of 15°, 20°, or 25°, and each upper limit value and each lower limit value may be discretionarily combined. The cutting edge angle influences the ratio between a component of force in the axis direction of the cutting force and a component of force in the radial direction of the cutting force, and the amount and sizes of burrs, and is discretionarily selected according to intended cutting. For example, as the cutting edge angle approaches the upper limit value, a component of force in the axial direction becomes smaller and a component of force in the radial direction becomes greater. As the cutting edge angle approaches the lower limit value, a component of force in the axial direction becomes greater and a component of force in the radial direction becomes smaller. As the cutting edge angle approaches the upper limit value, burrs are less likely to occur on the cutting surface.

The true rake angle has an upper limit value of −21°, −20° 17°, or −13°, and a lower limit value of 35°, −30°, or −25°, and each upper limit value and each lower limit value may be discretionarily combined. The smaller the true rake angle is, the greater the blade angle is, and a cutting edge strength is increased. The greater the true rake angle is, the smaller the cutting resistance becomes and the smaller the load applied on the cutting edge becomes. When the true rake angle is the lower limit value or greater and the upper limit value or smaller, the cutting edge strength and the load applied on the cutting edge are balanced, and occurrence of chipping is prevented during cutting and a stable lifespan is obtained.

In FIG. 1B, the cutting insert 10 in FIG. 1A is disposed such that the major cutting edge 11a is on the right side and the rotation center of the rotary cutting tool is on the left side. The cutting insert 10 is shown so as to indicate the orientations of the major cutting edge 11a and the wiper insert 11b as seen from sight lines (a) to (d) Each of sight lines (a) to (d) passes through a point at which the major cutting edge 11a and the wiper insert 11b meet, and an angle of a tangent plane at the point at which the major cutting edge 11a and the wiper insert 11b meet is calculated based on a direction as seen from each sight line. The sight line (a) is for measuring the true rake angle, and is an extension line of the major cutting edge 11a. The sight line (b) is for measuring a radial rake, and is parallel to the rotation axis.

The sight line (c) is for measuring a major cutting edge inclination angle, and is a line passing through the rotation axis in a direction perpendicular to the major cutting edge 11a. The sight line (d) is for measuring an axial rake, and extends in a direction perpendicular to the rotation axis. In FIG. 1B, a portion indicated by “(−)” in the sight lines (a) to (d) means that, in the portion, an angle indicated in the drawing has a negative value.

When the true rake angle is defined as T, the true rake angle is also calculated by tan T=Tan R×cosE+tan A×sinE in which R is a radial rake, A is an axial rake, and E is a cutting edge angle, although the true rake angle may be directly measured.

The major cutting edge inclination angle has an upper limit value of 4° or 2°, and a lower limit value of −4° or −2°, and each upper limit value and each lower limit value may be discretionarily combined. In particular, the major cutting edge inclination angle is preferably in a range of −1° to 1° and more preferably about 0°. When the major cutting edge inclination angle is the lower limit value or greater and the upper limit value or smaller, occurrence of chipping is prevented during cutting and a stable lifespan is obtained.

When the major cutting edge inclination angle is defined as I, the major cutting edge inclination angle is calculated by tan I=Tan A×cosE−tan R×sinE, although the major cutting edge inclination angle may be directly measured.

A radial rake R and an axial rake A are automatically determined when the cutting edge angle, the true rake angle, and the major cutting edge inclination angle are set.

When an axial rake of the CBN flat surface adjacent to the chamfer is 0° or a positive value, discharge of swarf is facilitated with the major cutting edge or the like.

### Modification 1

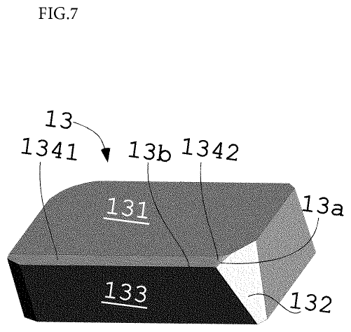

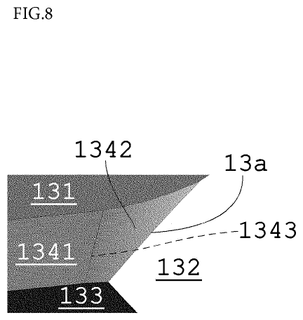

Modification 1 has the same configuration as that of the embodiment except that the blade part 11 is replaced with a blade part 13 as shown in FIG. 7 and FIG. 8. The blade part 13 is the same as the blade part 11 of the embodiment except for chamfers 1341 and 1342. The blade part 13 is formed of a cemented carbide layer and a CBN layer similarly to the blade part 11, but illustration in the drawings is omitted.

A chamfer 1341 is a part of a flat surface, and shifts to the chamfer 1342 having a rounded convex shape by changing a curvature at a boundary line 1343 shown in FIG. 8 so as to form a convex surface. The boundary line 1343 is indicated by a solid line, but neither appears on the surface as a pattern nor forms a ridgeline.

When the shape on a major cutting edge 13a side of the chamfer (chamfer 1342) is formed in a rounded convex shape, the effect similar to that obtained in a case where a chamfer is formed on the major cutting edge 13a without formation of a ridgeline between the chamfers 1341, 1342 is obtained. As compared to a case where a chamfer is formed on the major cutting edge 11a, a curved surface is merely formed in the formation when the chamfers 1341, 1342 are formed on the wiper insert 11b, leading to reduction in the number of steps required for processing.

### Modification 2

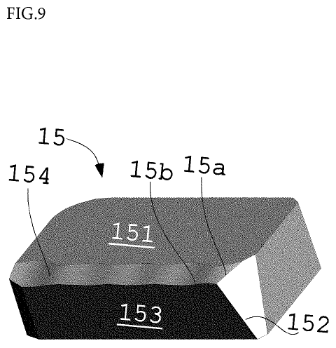

Modification 2 has the same configuration as that of the embodiment except that the blade part 11 is replaced with a blade part 15 as shown in FIG. 9. The blade part 15 is formed of a cemented carbide layer and a CBN layer similar to the blade part 11, but illustration in the drawings is omitted. The blade part 15 is similar to the blade part 11 of the embodiment except for the chamfer 154. The chamfer 154 is wavy, and has a rounded convex shape on the major cutting edge 15a side. Although not shown in FIG. 9, the wiper insert may be formed to be straight and only the chamfer may be wavy.

### Modification 3

Although the cutting insert of the rotary cutting tool according to the embodiment and modifications is detachably attached, the cutting insert may be fixed to the body 30 so as to prevent removal from the body 30.

### DESCRIPTION OF THE REFERENCE CHARACTERS

10 cutting insert
11, 13, 15 blade part
111 cemented carbide layer
112 CBN layer
12 base metal
11a, 13a, 15a major cutting edge
11b, 13b, 15b wiper insert
1121, 131, 151 rake surface
112, 132, 152 relief surface of major cutting edge
113, 133, 153 relief surface of wiper insert
1124, 1341, 1342, 154 chamfer
1343 boundary line at which curvature of chamfer changes
20 placement block
21 seat
30 body
35 fitting hole
41, 42 screw
T true rake angle
I major cutting edge inclination angle
E cutting edge angle
A axial rake
R radial rake

1. A cutting insert comprising a major cutting edge and a wiper insert which are formed of CBN, wherein
a chamfer extending to the major cutting edge and including a smooth surface formed at least near the major cutting edge is formed on a rake surface of the wiper insert.

2. The cutting insert according to claim 1, wherein the chamfer has a rounded convex shape on the major cutting edge side.

3. A rotary cutting tool comprising:
a blade part which includes a major cutting edge and a wiper insert which are formed of CBN, and in which a chamfer extending to the major cutting edge and including a smooth surface formed at least near the major cutting edge is formed on a rake surface of the wiper insert; and
a base part for securing the blade part, wherein
the blade part has a cutting edge angle that is greater than 0° and smaller than 90°, a true rake angle that is −42° or greater and −13° or smaller, and a major cutting edge inclination angle that is −5° or greater and smaller than +5°, and an axial rake of a surface other than the chamfer of the rake surface is 0° or greater in the blade part.

4. The rotary cutting tool according to claim 3, wherein
the blade part is replaceable.

5. The rotary cutting tool according to claim 3, wherein
the chamfer has a rounded convex shape on the major cutting edge side.

6. The rotary cutting tool according to claim 4, wherein
the chamfer has a rounded convex shape on the major cutting edge side.
